(19) United States
(12) Patent Application Publication
(10) Pub. No.: US 2026/0156185 A1
(43) Pub. Date: Jun. 4, 2026

(54) COMMUNICATION SYSTEM FOR A VEHICLE

(71) Applicant: Rivian IP Holdings, LLC, Irvine, CA (US)

(72) Inventors: Jesse SCHULTZ, Norman, IL (US); Jack DOAN, Albuquerque, NM (US); John HAINES, Morton, IL (US); Ben Noah DROBIZ, San Jose, CA (US); Michael POWERS, Santa Cruz, CA (US); Matt Tyson VANDER VLIET, Hopkins, MN (US); Sean BENTLEY, Laguna Niguel, CA (US)

(21) Appl. No.: 19/378,145

(22) Filed: Nov. 3, 2025

Related U.S. Application Data
(60) Provisional application No. 63/719,643, filed on Nov. 12, 2024.

(51) Int. Cl. H04L 67/12; H04L 12/40

(52) U.S. Cl. CPC H04L 67/12; H04L 12/40019; H04L 2012/40215; H04L 2012/40273

(57) ABSTRACT

In certain embodiments, a control system for an electric vehicle includes an electronic control unit (ECU) bus and a plurality of ECUs. A first ECU executes a broker service that communicates with a network server over a network, receives state information from applications executing on the ECUs, generates subscription information based on the state information, and transmits the subscription information to the applications that are subscribed to the subscription information. The first ECU also executes a translation service that communicates with the broker service and the ECU bus, and an application that generates state information, sends the state information to the broker service, and receives subscription information from the broker service. The second ECU executes an application that transmits state information over the ECU bus to the first ECU, and receives subscription information over the ECU bus from the first ECU.

### CROSS-REFERENCE TO RELATED APPLICATIONS

This application claims the benefit of U.S. Provisional Application Ser. No. 63/719,643 (filed on Nov. 12, 2024), the content of which is incorporated by reference herein in its entirety.

### INTRODUCTION

The present disclosure relates to communications systems. More particularly, the present disclosure relates to a communication system for an electric vehicle.

Vehicles use various ad hoc communication techniques to share data between applications running on network devices and applications running on the vehicle electronic control units (ECUs). After the data are generated, the data are sent through multiple communication channels and translations before the data are received for further processing.

### BRIEF DESCRIPTION OF THE DRAWINGS

FIG. 1 depicts a diagram of an example electric vehicle, in accordance with embodiments of the present disclosure.

FIG. 2 depicts a block diagram of example components of the electric vehicle, in accordance with embodiments of the present disclosure.

FIG. 3 depicts a block diagram of an example communication system, in accordance with embodiments of the present disclosure.

FIG. 4 depicts a flow diagram describing functionality for managing state information of the electric vehicle, in accordance with embodiments of the present disclosure.

FIG. 5 depicts a flow diagram describing functionality for event-driven or state-driven self-commissioning of an electric vehicle, in accordance with embodiments of the present disclosure.

FIG. 6 depicts a flow diagram describing functionality for managing state information for an electric vehicle, in accordance with certain embodiments of the present disclosure.

### DETAILED DESCRIPTION

In existing communication systems, there is no single representation for the data states and services that are available across the network devices and the vehicle ECUs. Further, applications running on network devices and vehicle ECUs must constantly revise the underlying code to accommodate changes in data structures and service application programming interfaces (APIs). Managing these platform and architectural variations becomes complicated and cumbersome. Consequently, it is difficult to share data and services across network devices and vehicle ECUs.

Embodiments of the present disclosure advantageously provide a communication system for a vehicle that includes a uniform communication fabric (also known as a secure data fabric) that is simple, convenient, efficient, and less prone to error. The secure data fabric encompasses data transmitted between network applications running on network devices and vehicle applications running on the ECUs, data transmitted between vehicle applications running on different ECU's, and data transmitted between vehicle applications running on the same ECU.

The network devices may include network servers, “cloud-based” network servers that provide cloud computing services, smartphones, personal computers, etc. The vehicle has a control system that includes a number of ECUs that are coupled to an ECU bus. Each ECU includes one or more processors that are configured to execute one or more software modules that are stored in a memory. At least one ECU includes a wireless transceiver that may be coupled to a wireless network (such as a cellular network, a WiFi network, etc.) that is coupled to a wide area network (WAN, such as the Internet, etc.).

The network applications and the vehicle applications work together to provide a suite of services within the communication system, such as backend services, user services, vehicle services, etc. More particularly, the network devices and the vehicle ECUs are nodes that form a distributed cluster for the secure data fabric. Data are generated by “producer” applications running on the network devices or the vehicle ECUs, transmitted through the secure data fabric, and received by “consumer” applications running on the vehicle ECUs or the network devices. Advantageously, an application that is connected to the secure data fabric on one node may produce data that may be consumed by other applications that are connected to the secure data fabric on any node.

The secure data fabric includes a messaging protocol and supporting infrastructure that provides the framework for producer applications to publish data and offer services to consumer applications, and for consumer applications to subscribe to published data and request services from producer applications. In certain embodiments, the communication messaging protocol implements the Neural Autonomic Transport System (NATS) protocol. In other embodiments, the communication messaging protocol may implement Apache Kafka, RabbitMQ, Apache Pulsar, gRPC, etc.

The communication system provides many technical advantages over existing ad hoc communication techniques. The secure data fabric provides eventual data consistency (also known as “at least once” semantics) by providing the latest state of the relevant data to consumer applications, followed by the remaining states of the relevant data. Alternatively, the secure data fabric may also compress the changes to the data states to the last known data state, which is provided to the consumer applications. The secure data fabric provides partition tolerance so that nodes in the distributed cluster may operate independently, and may synchronize (opportunistically) based on connectivity to the secure data fabric. When a data state changes, the secure data fabric provides asynchronous event notifications with flow control to the consumer applications. The data state changes may also be prioritized. In addition to data, a producer application may also provide services to consumer applications connected to the secure data fabric, which is analogous to a remote procedure call (RPC).

While aspects of the present disclosure are discussed in the context of an electric vehicle (EV), the disclosure supports any type of vehicle, such as an internal combustion engine vehicle (ICEV), a hybrid electric vehicle (HEV), etc.

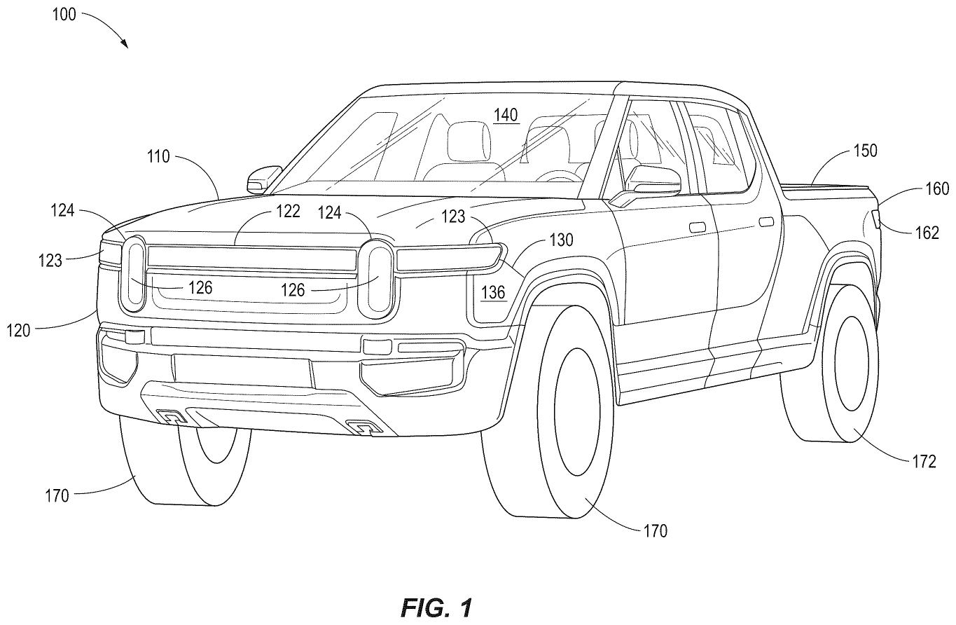

FIG. 1 depicts a diagram of an example electric vehicle 100, in accordance with embodiments of the present disclosure.

Electric vehicle 100 includes, inter alia, a frame and body 110, an electrical power storage and distribution system, a propulsion system, a suspension system, a steering system, a control system, auxiliary and accessory systems (such as thermal management, lighting, wireless communications, navigation, etc.), etc.

Generally, body 110 may be directly or indirectly mounted to a frame (i.e., body-on-frame construction), or body 110 may be formed integrally with a frame (i.e., unibody construction). Body 110 includes, inter alia, front end 120, front light bar 122, front turn lights 123, stadium light rings 124, headlights 126, charging port 130 with charging port cover 136 concealing charging connector socket, driver/passenger compartment or cabin 140, bed 150, rear end 160 with rear tail lights 162, a rear light bar, etc. Electric vehicle 100 may be a pickup truck, a sport utility vehicle (SUV) in which bed 150 is replaced by an extension of cabin 140, or a sedan in which bed 150 is replaced by a trunk. In certain embodiments, electric vehicle may be an electric delivery vehicle, an electric cargo van, etc.

The propulsion system may include, inter alia, one or more ECUs, one or more electric drive unit (EDUs), front wheels 170, rear wheels 172, etc. The electrical power storage and distribution system may include, inter alia, one or more ECUs, a battery enclosure including a housing containing a traction battery, a vehicle charging subsystem including charging port 130, a high voltage (HV) wiring harness connecting the traction battery to the other HV electrical system components, such as the EDUs, etc.

A single motor EDU may be used to drive front wheels 170 (front wheel drive) or rear wheels 172 (rear wheel drive). Additionally, a single motor EDU may be used to drive front wheels 170 and a single motor EDU may be used to drive rear wheels 172 (four wheel drive). A dual motor EDU may be used to independently drive front wheels 170 (independent front wheel drive) or rear wheels 172 (independent rear wheel drive). Additionally a dual motor EDU may be used to independently drive both front wheels 170 and a dual motor EDU may be used to independently drive both rear wheels 172 (independent four wheel drive).

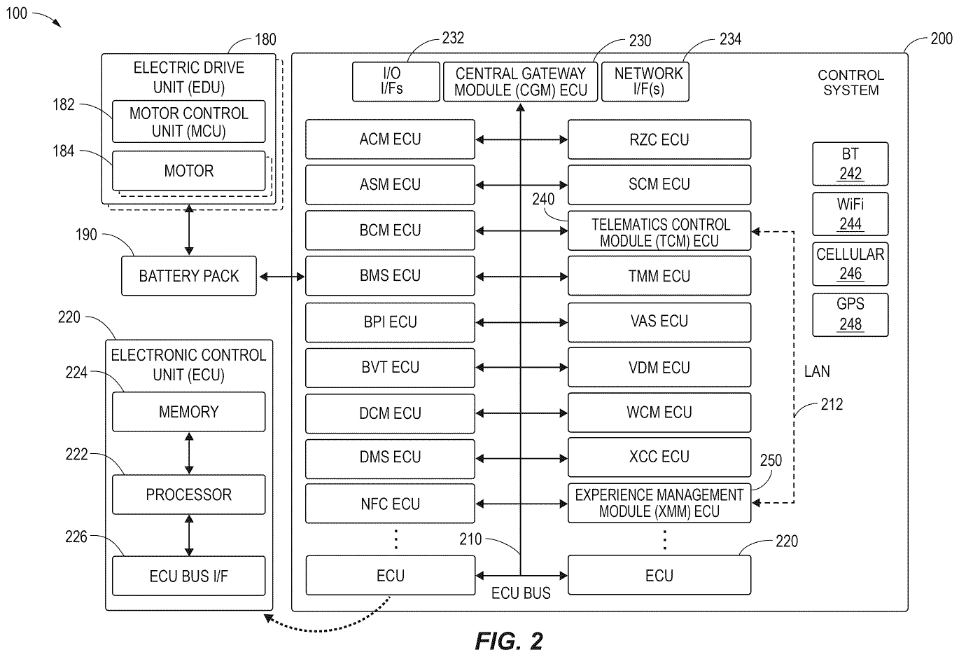

FIG. 2 presents a block diagram of example components of electric vehicle 100, in accordance with embodiments of the present disclosure.

Generally, electric vehicle 100 includes control system 200 that is configured to perform the functions necessary to operate electric vehicle 100. In certain embodiments, control system 200 includes a number of ECUs 220 coupled to ECU bus 210 (such as a controller area network or CAN bus, a local area network or LAN, etc.). Each ECU 220 performs a particular set of functions, and includes, inter alia, one or more processor(s) 222 coupled to memory 224 and ECU bus interface (I/F) 226. ECUs 220 may include central gateway module (CGM) ECU 230, telematics control module (TCM) ECU 240, experience management module (XMM) ECU 250, etc.

ECU bus 210 implements a message based communication protocol over a physical infrastructure or layer. For example, ECU bus 210 may be a CAN bus that implements ISO 11898 (CAN protocol) over twisted, differential pair wiring that carries the CAN_H and CAN_L data signals. In another example, ECU bus 210 may be a LAN that implements IEEE 802.3 (Ethernet protocol) over wired cables (such as a CAT-8 Ethernet cable, etc.), fiber optic cables, etc. In some embodiments, control system 200 may include an additional LAN 212 that connects certain ECUs 220, such as TCM ECU 240, XMM ECU 250, etc. LAN 212 may be configured to communicate data between these particular ECUs without interfering with the flow of data through ECU bus 210.

Processor 222 may be a microcontroller unit, a microprocessing unit, a central processing unit (CPU), a programmable logic device (PLD), a complex PLD, a field programmable gate array (FPGA), an application specific integrated circuit (ASIC), etc. Memory 224 may include volatile and non-volatile memory, such as random access memory (RAM), static RAM (SRAM), dynamic RAM (DRAM), read only memory (ROM), flash memory, universal flash storage (UFS), solid state drives (SSDs), etc. Processor 222 may execute a real time operating system (RTOS), such as VxWorks, Integrity, a proprietary RTOS, etc. In certain embodiments, one or more ECUs 220 may include one or more multi-core processors 222 that execute an operating system that supports high-volume multithreading applications (such as Linux, Unix, BSD, etc.), etc., such as TCM ECU 240, XMM ECU 250, etc.

In certain embodiments, control system 200 may include a number of system-on-chips (SoCs). Each SoC may include a number of multi-core processors coupled to a high-speed interconnect and on-chip memory that provide more robust functionality and performance than a single ECU 220. Accordingly, each SoC may combine the functionality provided by several ECUs 220.

Control system 200 may be coupled to sensors (such as cameras, radar sensors, ultrasonic sensors, etc.), actuators (such as electric, hydraulic, pneumatic, etc.), input/output (I/O) devices, as well as other components within the propulsion system, the electrical power storage and distribution system, the suspension system, the steering system, the auxiliary and accessory systems, etc., such as EDU 180, battery pack 190, etc.

CGM ECU 230 provides a central communications hub for electric vehicle 100. CGM ECU 230 includes (or is coupled to) I/O I/F(s) 232 to receive data from, and send commands to, various vehicle components, such as sensors, actuators, input devices, output devices, etc. CGM ECU 230 also includes (or is coupled to) network I/F(s) 234 to provide network connectivity through ECU bus ports, local interconnect network (LIN) ports, Ethernet ports, etc.

CGM ECU 230 may route messages (including commands, data, etc.) over ECU bus 210 from one ECU 220 to another ECU 220, or from one ECU 220 to multiple ECUs 220 (such as broadcast messages, etc.). In one example, CGM ECU 230 may receive a message from a source ECU 220, process the message to determine, inter alia, the destination ECU 220, and then transmit the message to the destination ECU 220. In another example, CGM ECU 230 may simply arbitrate ECU bus 210 to allow the source ECU 220 to send a message directly to the destination ECU 220.

CGM ECU 230 may receive data from a sensor, an I/O device, a vehicle component, etc., and then send a message containing the data to the appropriate ECU 220 over ECU bus 210. Similarly, CGM ECU 230 may receive a message containing a command or data from a source ECU 220, and then send the command or the data to the appropriate actuator, I/O device, vehicle component, etc. Additionally, CGM ECU 230 may manage the vehicle mode (such as road driving mode, off-roading mode, tow mode, camping mode, parked mode, etc.), and may control certain vehicle components related to transitioning from one vehicle mode to another vehicle mode.

TCM ECU 240 which provides a wireless communications hub for electric vehicle 100. TCM ECU 240 may include or may be coupled to Bluetooth (BT) or Bluetooth Low Energy (BLE) transceiver 242, WiFi transceiver 244, cellular network transceiver 246 configured to transmit and receive data over a cellular data connection, etc. TCM ECU 240 may also include global positioning system (GPS) receiver 248.

In certain embodiments, control system 200 may also include, inter alia, autonomy control module (ACM) ECU, autonomous safety module (ASM) ECU, body control module (BCM) ECU, battery management system (BMS) ECU, battery power isolation (BPI) ECU, balancing voltage temperature (BVT) ECU, door control module (DCM) ECU, driver monitoring system (DMS) ECU, near-field communication (NFC) ECU, rear zone control (RZC) ECU, seat control module (SCM) ECU, thermal management module (TMM) ECU, vehicle access system (VAS) ECU, winch control module (WCM) ECU, motor control unit (XCC) ECU, etc.

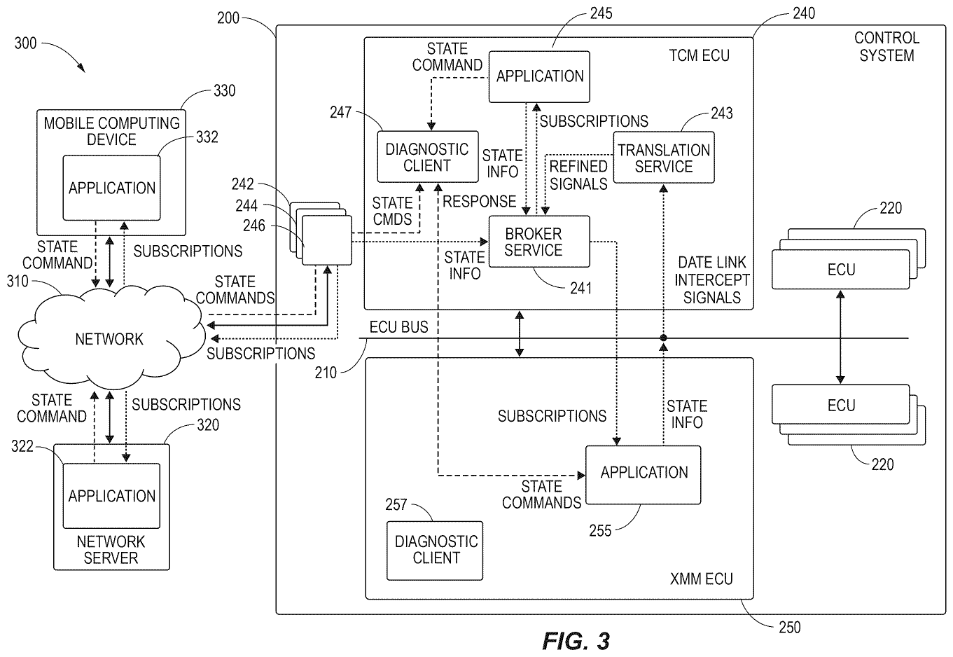

FIG. 3 depicts a block diagram of communication system 300, in accordance with embodiments of the present disclosure.

In certain embodiments, communication system 300 includes, inter alia, network 310, one or more network servers 320 configured to execute one or more applications 322 (e.g., a manufacturing execution system or MES, etc.), one or more mobile computing devices 330 (e.g., smartphones, tablets, laptop computers, etc.) configured to execute one or more applications 332 (e.g., a smartphone app, etc.), and ECUs 220 of control system 200, such as TCM ECU 240 with BT/BLE transceiver 242, WiFi transceiver 244, and cellular network transceiver 246, XMM ECU 250, etc. Each ECU 220 is configured to execute one or more applications, service modules, etc. For example, TCU ECU 240 may be configured to execute broker service 241, translation service 243, application 245, and diagnostic client 247, and XMM ECU 250 may be configured to execute application 255. Additional diagnostic clients that perform the same or similar functionality as diagnostic client 247 may be hosted by other components of the communication system 300, such as a diagnostic client hosted by network server 320, diagnostic client 257 hosted by XMM ECU 250, and so on.

Network 310 may include one or more LANs, wireless LANs (WLANs), WANs (such as the Internet, etc.), etc., which may execute various network protocols, such as, for example, Ethernet, Bluetooth, WiFi, etc. Network 310 may also include various combinations of wired and/or wireless physical layers, such as, for example, copper wire or coaxial cable networks, fiber optic networks, Bluetooth wireless networks, WiFi wireless networks, CDMA, FDMA and TDMA cellular wireless networks, etc.

In certain embodiments, network server 320 may be coupled to a LAN (or respective LANs) that is coupled to a WAN (such as the Internet, etc.). BT/BLE transceiver 242 may be coupled to a Bluetooth network device, which is coupled to the LAN. WiFi transceiver 244 may be coupled to a WiFi wireless network which is coupled to the WAN. Cellular network transceiver 246 may be coupled to a CDMA, FDMA or TDMA cellular wireless network, which is coupled to the WAN. Generally, network 310 includes the LANs and WANs necessary to interconnect network server 320 and electric vehicle 100.

### Real-Time Vehicle Health and State Monitoring and Communication

Embodiments of the present disclosure advantageously provide real-time monitoring and communication of a vehicle's health status using an ECU 220 (such as TCM ECU 240) to enhance operational decision-making and efficiency. State information is passively and actively aggregated from electric vehicle 100 and its components by broker service 241 to create an internal model of the health of vehicle 100 and its components. This information is then translated into actionable states or statuses that are accessible as subscriptions to applications executing on ECUs 220 (such as application 245 executing on TCM ECU 240, application 255 executing on XMM ECU 250, etc.), other systems (such as application 322 (e.g., the MES) executing on network server 320, etc.), user devices (e.g., application 332 executing on the mobile computing device 330), etc.

Certain functionality includes real-time visibility of vehicle health and component state, which enables instant access to detailed vehicle information thus empowering operators with actionable insights and streamlining workflows by providing granular status updates. Direct feedback may be provided to automated systems about state change both prior and post action. Additional functionality includes adaptability across various environments where real-time health communication is essential, facilitating enhanced issue escalation, improved quality control, and more efficient operation of vehicles in transit or work-in-progress. Additionally, integration with quality checkpoints and management systems is also provided, ensuring consistent communication, reducing diagnostic time, and supporting decision-making through a standardized data framework.

For example, state information (or state info) may be provided by application 245 directly to broker service 241 executing on TCM 240. The state information may include vehicle data (e.g., one or more vehicle parameters, etc.) that are provided by application 245, and broker service 241 publishes the state information as one or more subscriptions that are available to other applications (e.g., application 255, application 322, application 332, etc.). A subscription may include a single data point (e.g., vehicle parameter), a set of related data points (e.g., related vehicle parameters), and so on.

State changes may be aggregated and provided in plain language to operators, and the transport and consumption of state changes are also facilitated. For example, battery voltage may be consumed and translated into “ok” or “nok” (not ok) for an operator depending on the voltage range.

### Translating and Publishing Vehicle Communication Signals to On-Change, Rate Limited, Events to Which Applications May Subscribe

Embodiments of the present disclosure advantageously provide translation service 243 that receives or intercepts CAN or Diagnostic over Internet Protocol (DoIP) messages from ECU bus 210 (in raw UDP format), translates the intercepted CAN messages into refined signals defined by a CAN database (DBC), and then sends the refined signals to broker service 241 for publication through one or more subscriptions. Filters may be provided for “only on change” and automatic rate limiting of the data.

For example, state information may be provided by application 255 executing on XMM ECU 250 indirectly to broker service 241 executing on TCM 240 via the ECU bus 210 and the translation service 243. More particularly, application 255 encodes state information as one or more CAN (or DoIP) messages that are provided to the ECU bus 210. Translation service 243 intercepts and converts the CAN messages on ECU bus 210 into data link intercept signals and then translates the data link intercept signals into refined signals that are provided to broker service 241 for publication as one or more subscriptions that are available to other applications (e.g., application 245, application 322, application 332, etc.).

Advantageously, the need to handle data processing is abstracted away from an application running on an ECU 220 at any level lower than listing the signals, including handling of redundant or recurrent information. An application simply specifies which signals it needs from ECU bus 210, and receives them only on change, and at a specific maximum rate of change to the signals. Consumption of all traffic on ECU bus 210 is allowed, and translation of the traffic into published messages for internal ECU traffic is prefixed by specific names defined in a database, with raw data to consumable data translation.

For example, ECU bus 210 may include a signal that includes state information describing the battery voltage from an ECU 220 (e.g., the BMS ECU). The battery voltage data may be received, a rate limit applied, and subscribers and data brokers on the ECUs 220 may be notified when the battery voltage data value changes.

### Subscription to Vehicle State and Diagnostic Data

Generally, broker service 241 provides subscriptions to facilitate communication between ECUs 220 (e.g., TCM ECU 240, XMM ECU 250, etc.) and messages/events in application 322 (e.g., the MES) executing on network server 320. More particularly, event driven state or diagnostic data from electric vehicle 100 are presented to the MES in real time, as well as a way for the MES to present event driven changes to electric vehicle 100 in real time. Similarly, broker service 241 provides subscriptions to facilitate communication between ECUs 220 (e.g., TCM ECU 240, XMM ECU 250, etc.) and messages/events in application 332 executing on mobile computing device 330.

For example, application 322 (e.g., the MES) may subscribe to state information provided by application 255 executing on the XMM ECU 250. Based on an analysis of the state information (and possibly other data), the application 322 may decide to update the state information to reflect a more current view of the vehicle data (e.g., one or more vehicle parameters) reflected by the state information. Application 322 may send a state command to diagnostic client 247 executing on TCM ECU 240 through network 310 to update the state information provided by application 255. Diagnostic client 247 then sends the state command to application 255 executing on XMM ECU 250 through the ECU bus 210.

Application 255 may then decide whether application 322 has permission to update the state information. If application 322 is not authorized to update the state information, application 255 sends a response to diagnostic client 247 indicating that the state command is not allowed. If application 322 is authorized to update the state information, application 255 attempts to change the state information based on the state command. If successful, application 255 sends a response to diagnostic client 247 indicating that the state command was successful. If not successful, application 255 sends a response to diagnostic client 247 indicating that the state command was not successful.

In some embodiments, diagnostic client 247 may send a response to application 322 indicating whether the state command was successful. If the state command was not successful, application 322 may repeat the process by sending the state command again to diagnostic client 247 to update the state information provided by application 255. In some embodiments, application 322 may start a timer that, after a predetermined time, repeats the process by sending the state command again to diagnostic client 247 to update the state information provided by application 255 until the subscription to the state information indicates that the updated state information has been received from application 255 by broker service 241.

Similarly, application 245 executing on TCM ECU 240 may subscribe to state information provided by application 255. Based on an analysis of the state information (and possibly other data), the application 245 may decide to update the state information to reflect a more current view of the vehicle data (e.g., one or more vehicle parameters) reflected by the state information. Application 245 may send a state command to diagnostic client 247 to update the state information provided by application 255. And so on.

Generally, a first application may update the state information provided by a second application provided the first application has permission to do so.

Applications executing on ECUs 220, network server 320, and mobile computing device 330 may create a tight cohesion with event driven, real time data. For example, application 322 and application 332 may subscribe to real time event data from one or more ECUs 220 and create patterns or reactions to changes in that data. Similarly, applications running on ECUs 220 (e.g., application 245, application 255, etc.) may also subscribe to real time event data published from network servers 320 and mobile computing devices 330 and create patterns or reactions to changes in the these data.

For example, electric vehicle 100 may have a door change state from an open position to closed position. The ECU 220 hosting the application that manages the door state would send the state information over the ECU bus 210, which is intercepted by translation service 243, converted into a data link intercept signal, and then translated into a refined signal that is provided to broker service 241 for publication as one or more subscriptions that are available to other applications. An off-vehicle system (such as the MES) subscribed to the door state from the electric vehicle 100 would be notified of the change in state in real time at the time of the event. The MES may then use the door status to prevent a calibration from running.

In another example, the applications executing on the ECUs 220 may consume state information describing “production status” or position in the plant provided by the MES, or even vehicle ownership ID directly from MES in real time.

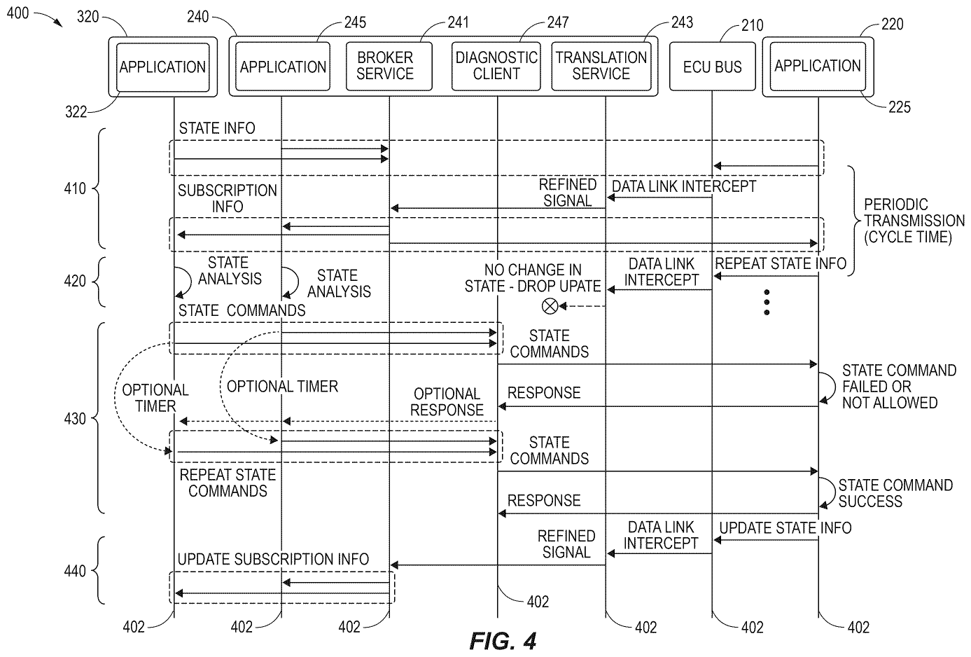

FIG. 4 depicts a flow diagram 400 describing functionality for managing state information of electric vehicle 100, in accordance with embodiments of the present disclosure.

Generally, flow diagram 400 depicts information flowing between certain components of communication system 300, including of network server 320, TCM ECU 240, ECU bus 210, and a generic ECU 220 (e.g., XMM ECU 250). Time is represented as a vertical axis 402 associated with each component of communication system 300, progressing from the top of the flow diagram 400 to the bottom of the flow diagram 400. Network server 320 executes application 322. TCM ECU 240 executes broker server 241, translation service 243, application 245, and diagnostic client 247. ECU 220 executes application 225.

Sequence 410 generally depicts state information flowing from application 322, application 245, and application 225 to broker service 241, and subscriptions (subscription information) flowing from broker service 241 to application 322, application 245, and application 225. Application 322 sends state information to and receives subscription information from broker service 241 over network 310. Application 245 sends state information directly to and receives subscription information directly from broker service 241, as these components are both executing on TCM ECU 240.

Application 225 sends state information to and receives subscription information from broker service 241 over ECU bus 210. More particularly, application 225 encodes state information as one or more CAN (or DoIP) messages that are provided to the ECU bus 210. Translation service 243 intercepts and converts the CAN messages on ECU bus 210 into data link intercept signals and then translates the data link intercept signals into refined signals that are provided to broker service 241 for publication as one or more subscriptions that are available to other applications (e.g., application 245, application 322).

In certain embodiments, application 225 may periodically transmit state information over ECU bus 210 based on a cycle time, such as every second, every 5 seconds, and so on. Translation service 243 intercepts and converts the CAN messages on ECU bus 210 into data link intercept signals, and then compares the current data link intercept signals to the previous data link intercept signals for application 225. If the current and previous data link intercept signals are the same, then the state information has not changed and the translation service 243 does not translate the data link intercept signals into refined signals. In other words, translation service 243 drops the state update.

Generally, broker service 241 publishes state information as subscription information. As described above, a subscription may include a single data point (e.g., vehicle parameter), a set of related data points (e.g., vehicle parameters), and so on. Each application may subscribe to one or more subscriptions provided by broker service 241. For example, application 322 may subscribe to certain state information provided by application 245 and application 225. Application 245 may subscribe to certain state information provided by application 322 and application 225, and application 225 may subscribe to certain state information provided by application 322 and application 245. In certain embodiments, an application may analyze the state information provided by a particular subscription to determine whether to update the state information in that subscription.

Sequence 420 generally depicts an analysis phase for application 322 and application 245, each of which subscribes to state information provided by ECU 220.

For example, application 322 (e.g., the MES) may subscribe to state information provided by application 225 executing on ECU 220. Based on an analysis of the state information (and possibly other data), application 322 may decide to update the state information to reflect a more current view of the vehicle data (e.g., one or more vehicle parameters) reflected by the state information.

Similarly, application 245 may subscribe to state information provided by application 225 executing on ECU 220. Based on an analysis of the state information (and possibly other data), the application 245 may decide to update the state information to reflect a more current view of the vehicle data (e.g., one or more vehicle parameters) reflected by the state information.

Sequence 430 generally depicts a state command phase for application 322 and application 245, each of which subscribes to state information provided by application 225. While the following description uses application 322 as an example, in various embodiments, the process is the same for application 245.

Application 322 may send a state command to diagnostic client 247 through network 310 to update the state information provided by application 225. The state command includes updated state information. Diagnostic client 247 determines that the state command is associated with application 225, determines that application 225 is executing on the ECU 220, and sends the state command to application 225 executing on ECU 220 through ECU bus 210.

Application 225 then determines whether application 322 has permission to update the state information. If application 322 is not authorized to update the state information, application 225 sends a response to diagnostic client 247 indicating that the state command is not allowed. If application 322 is authorized to update the state information, application 225 attempts to change the state information based on the state command. If successful, application 225 sends a response to diagnostic client 247 indicating that the state command was successful. If not successful, application 225 sends a response to diagnostic client 247 indicating that the state command was not successful.

In some embodiments, diagnostic client 247 may send a response to application 322 indicating whether the state command was successful. If the state command was not successful, application 322 may repeat the process by sending the state command to diagnostic client 247 again to update the state information provided by application 225. In some embodiments, application 322 may start a timer that, after a predetermined time, repeats the process by sending the state command again to diagnostic client 247 to update the state information provided by application 225 until the subscription to the state information indicates that the updated state information has been received from application 225.

Sequence 440 generally depicts updated state information flowing from application 225 to broker service 241, and updated subscription information flowing from broker service 241 to application 322 and application 245. As discussed with respect to sequence 410, application 225 encodes updated state information as one or more CAN (or DoIP) messages that are provided to the ECU bus 210. Translation service 243 intercepts and converts the CAN messages on ECU bus 210 into data link intercept signals and then translates the data link intercept signals into refined signals that are provided to broker service 241 for publication as updated subscription information for application 322 and application 245.

### Event and State Driven Self-Commissioning

Embodiments of the present disclosure provide a method for electric vehicle 100 or an off-vehicle MES (e.g., application 322) to initiate or complete vehicle commissioning steps using changes in the vehicle state, or changes in production or assembly events. In certain embodiments, a method defines and executes commissioning steps as an event reaction to either vehicle state changes or changes in the assembly process.

The commissioning steps may be preformed by either the ECUs 220 on electric vehicle 100 or the off-vehicle MES in a way that is abstract from the steps themselves. The commissioning steps may be defined with a list of pre-conditional data and trigger events, and executed in real time as reactions to the pre-conditional data changing or the trigger events. Automation allows electric vehicle 100 to complete self-commissioning of critical manufacturing or service steps in reaction to operator actions or changes in meta status on external systems. The MES may also complete follow up actions based on changes to the vehicle state in ways that simplify automation and ensure tight feedback. A feedback loop allows for repeated attempts and closure of the status only on successful completion, enabling full feedback control of commissioning steps.

For example, an operator factory-OKs a VIN in the MES, and that event may be used to drive sub-tasks within application 225 executing on one or more ECUs 220 on electric vehicle 100 (e.g., application 245 executing on TCM ECU 240, application 255 executing on XMM ECU 250, etc.). In another example, an operator finishes plugging in a seat assembly on electric vehicle 100, and that event (such as a change in a “seat connection state”) may trigger a quality update in the MES, which then runs a commissioning task like “calibrate front seat.” Advantageously, the events may occur on the MES or on electric vehicle 100.

In another example, a transporter parks electric vehicle 100 in a specific lot. An ECU 220 may parse the change in drive cycle state as well as the current ownership state to enable automatic mode changes to conserve energy.

In another example, after a final step of the assembly process is performed, a notification may be sent to the MES indicating that electric vehicle 100 is ready to complete. The MES may use that event to trigger one or more commissioning steps on the vehicle, such as “Enabling Immobilizer,” resetting user data, etc.

In another example, a resale of a vehicle event with a change in ownership state may trigger a communication of the state change from network server 320 to electric vehicle 100, and a commissioning step of “wiping all previous private data.”

In another example, an operator on an assembly line completes a connection to electric vehicle 100, which automates a reaction or notification in the MES to cancel a quality alert.

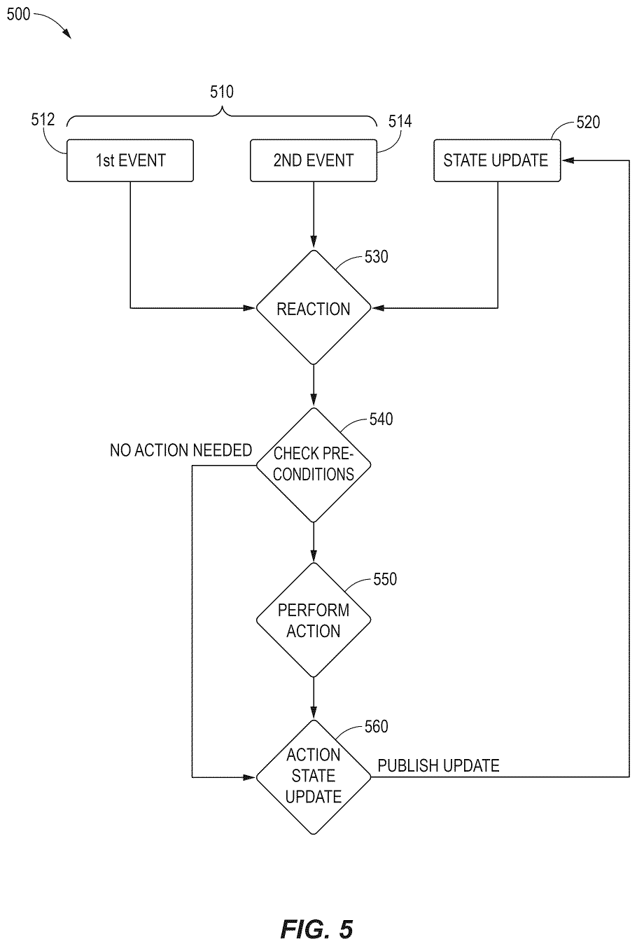

FIG. 5 depicts a flow diagram 500 describing functionality for event-driven or state-driven self-commissioning of electric vehicle 100, in accordance with embodiments of the present disclosure.

In certain embodiments, an event 510 (such as 1^{st} Event 512, 2^{nd} Event 514, etc.) or a state update 520 (such as a commissioning task state update, etc.) may cause a reaction 530 to the event 510 or the state update 520. Pre-conditions may then be checked 540 to determine whether an action is needed. If an action is needed, the action is performed 550, and an action state is updated 560. For example, the action state may be updated as “completed” if the action was completed, or the action state may be updated as “not completed” if the action was not completed. If an action is not needed, the action state is simply updated 460. For example, the action state may be updated as “completed,” “not needed,” and so on. The action state is then published to the state update 520, which may cause a further reaction 530 to the state update 520, and so on.

As described above, the functionality depicted in the flow diagram 500 may be performed by application 245 executing on the TCM ECU 240 and/or application 255 executing on the XMM ECU 250. In other embodiments, the functionality depicted in the flow diagram 500 may be performed by application 245 executing on the TCM ECU 240 and/or application 255 executing on the XMM ECU 250 in cooperation with application 322 executing on the network server 320 (e.g., the MES). Generally, the functionality depicted in the flow diagram 500 may be performed by one or more applications executing on one or more ECUs 220 optionally in cooperation with application 322 (e.g., the MES) executing on the network server 320 and/or an application 332 executing on the mobile computing device 330.

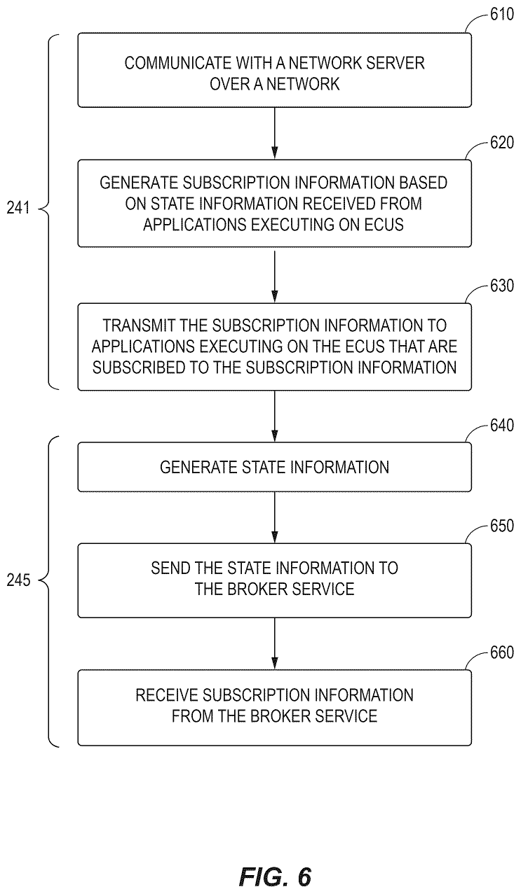

FIG. 6 depicts a flow diagram 600 describing functionality for managing state information for electric vehicle 100, in accordance with certain embodiments of the present disclosure.

Generally, the functionality for managing state information is performed by a processor 222 of an ECU 220, such as the processor of the TCM ECU 240 which is configured to execute broker service 241 and application 245. Blocks 620, 620, 630, and 640 are performed by broker service 241, while blocks 650, 660, and 670 are performed by application 245.

At block 610, broker service 241 communicates with network server 320 over network 310.

At block 620, broker service 241 generates subscription information based on state information received from applications executing on ECUs 220 coupled to ECU bus 210, such as application 255 executing on XMM ECU 250.

At block 630, broker service 241 transmits the subscription information to the applications executing on the ECUs 220 that are subscribed to the subscription information, such as application 255.

At block 640, application 245 generates state information.

At block 650, application 245 sends the state information to broker service 241.

At block 660, application 245 receives subscription information from broker service 241.

The many features and advantages of the disclosure are apparent from the detailed specification, and, thus, it is intended by the appended claims to cover all such features and advantages of the disclosure which fall within the scope of the disclosure. Further, since numerous modifications and variations will readily occur to those skilled in the art, it is not desired to limit the disclosure to the exact construction and operation illustrated and described, and, accordingly, all suitable modifications and equivalents may be resorted to that fall within the scope of the disclosure.

What is claimed is:

1. A control system for an electric vehicle, the control system comprising:
an electronic control unit (ECU) bus; and
a plurality of ECUs coupled to the ECU bus, the ECUs comprising:
a first ECU configured to:
execute a broker service configured to communicate with a network server over a network;
generate subscription information based on state information received from applications executing on the ECUs;
transmit the subscription information to one or more of the applications executing on the ECUs that are subscribed to the subscription information; and
execute a translation service configured to communicate with the broker service and the ECU bus; and
a second ECU configured to:
execute an application that is configured to transmit state information over the ECU bus to the first ECU; and
receive subscription information over the ECU bus from the first ECU.

2. The control system of claim 1, wherein the translation service is configured to:
receive the state information from the second ECU over the ECU bus in a first format;
convert the state information in the first format to state information in a second format; and
provide the state information in the second format to the broker service.

3. The control system of claim 2, wherein the translation service is further configured to:
receive additional state information from the second ECU over the ECU bus in the first format;
determine whether the additional state information is different than the state information; and
when the additional state information is different than the state information, convert the state information in the first format to state information in the second format, and provide the state information in the second format to the broker service.

4. The control system of claim 1, wherein:
the first ECU is further configured to execute an application that is configured to:
generate state information;
send the state information to the broker service; and
receive subscription information from the broker service;
an application executing on the network server is subscribed to the subscription information; and
the broker service is further configured to transmit the subscription information to the application executing on the network server over the network.

5. The control system of claim 4, wherein the broker service is further configured to:
receive additional state information from the application executing on the network server;
generate additional subscription information based on the additional state information received from the network server; and
transmit the additional subscription information to the applications executing on the ECUs that are subscribed to the additional subscription information.

6. The control system of claim 4, wherein:
the first ECU is further configured to execute a diagnostic client; and
the diagnostic client is configured to:
receive a state command from the application executing on the network server, wherein the state command is associated with an application transmitting state information, and the state command comprises updated state information;
determine which ECU is executing the application transmitting the state information; and
send the state command to the determined ECU over the ECU bus.

7. The control system of claim 6, wherein the application associated with the state command is configured to:
determine whether the state command is authorized;
when the state command is authorized, change the state information to the updated state information; and
transmit the updated state information over the ECU bus to the first ECU.

8. An electronic control unit (ECU) for an electric vehicle, the ECU comprising:
a memory; and
a processor coupled to the memory and an ECU bus, the processor configured to:
execute a broker service configured to:
communicate with a network server over a network,
generate subscription information based on state information received from applications executing on ECUs coupled to the ECU bus, and
transmit the subscription information to one or more of the applications executing on the ECUs that are subscribed to the subscription information;
execute a translation service configured to communicate with the broker service and the ECU bus; and
execute a first application configured to:
generate state information,
send the state information to the broker service, and
receive subscription information from the broker service.

9. The ECU of claim 8, wherein the translation service is configured to:
receive the state information from an application executing on an ECU over the ECU bus in a first format;
convert the state information in the first format to state information in a second format; and
provide the state information in the second format to the broker service.

10. The ECU of claim 9, wherein the translation service is further configured to:
receive additional state information from the application executing on the ECU over the ECU bus in the first format;
determine whether the additional state information is different than the state information; and
when the additional state information is different than the state information, convert the state information in the first format to state information in the second format, and provide the state information in the second format to the broker service.

11. The ECU of claim 8, wherein:
an application executing on the network server is subscribed to the subscription information; and
the broker service is further configured to transmit the subscription information to the application executing on the network server.

12. The ECU of claim 11, wherein the broker service is further configured to:
receive additional state information from the application executing on the network server;
generate additional subscription information based on the additional state information received from the network server; and
transmit the additional subscription information to the applications executing on the ECUs that are subscribed to the additional subscription information.

13. The ECU of claim 11, wherein:
the processor is further configured to execute a diagnostic client; and
the diagnostic client is configured to:
receive a state command from the application executing on the network server, wherein the state command is associated with an application transmitting state information, and the state command comprises updated state information;
determine which ECU is executing the application transmitting the state information; and
send the state command to the determined ECU over the ECU bus.

14. The ECU of claim 13, wherein the diagnostic client is further configured to:
receive updated state information from the application executing on the determined ECU over the ECU bus.

15. A method for managing state information for an electric vehicle, the method comprising:
communicating, by a broker service executing on an electronic control unit (ECU) coupled to an ECU bus, with a network server over a network,
generating, by the broker service, subscription information based on state information received from applications executing on ECUs coupled to the ECU bus, and
transmitting, by the broker service, the subscription information to one or more of the applications executing on the ECUs that are subscribed to the subscription information;
generating, by a first application executing on the ECU, state information,
sending, by the application, the state information to the broker service, and
receiving, by the application, subscription information from the broker service.

16. The method of claim 15, further comprising:
receiving, by a translation service executing on the ECU, the state information from an application executing on an ECU over the ECU bus in a first format;
converting, by the translation service, the state information in the first format to state information in a second format; and
providing, by the translation service, the state information in the second format to the broker service.

17. The method of claim 16, further comprising:
receiving, by the translation service, additional state information from the application executing on the ECU over the ECU bus in the first format;
determining, by the translation service, by the translation service, whether the additional state information is different than the state information; and
when the additional state information is different than the state information, converting, by the translation service, the state information in the first format to state information in the second format, and providing the state information in the second format to the broker service.

18. The method of claim 15, wherein:
an application executing on the network server is subscribed to the subscription information; and
the method further comprises transmitting, by the broker service, the subscription information to the application executing on the network server.

19. The method of claim 18, further comprising:
receiving, by the broker service, additional state information from the application executing on the network server;
generating, by the broker service, additional subscription information based on the additional state information received from the network server; and
transmitting, by the broker service, the additional subscription information to the applications executing on the ECUs that are subscribed to the additional subscription information.

20. The method of claim 18, further comprising:
receiving, by a diagnostic client, a state command from the application executing on the network server, wherein the state command is associated with an application transmitting state information, and the state command comprises updated state information;
determining, by the diagnostic client, which ECU is executing the application transmitting the state information;
sending, by the diagnostic client, the state command to the determined ECU over the ECU bus; and
receiving, by the diagnostic client, updated state information from the application executing on the determined ECU over the ECU bus.
